(19) United States
(12) Patent Application Publication
(10) Pub. No.: US 2026/0052580 A1
(43) Pub. Date: Feb. 19, 2026

(54) RANDOM ACCESS OCCASION TYPE SWITCHING TIMELINES FOR SUBBAND FULL DUPLEX DEVICES

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Jae Ho RYU, San Diego, CA (US)

(21) Appl. No.: 19/258,666

(22) Filed: Jul. 2, 2025

Related U.S. Application Data
(60) Provisional application No. 63/684,792, filed on Aug. 19, 2024.

(51) Int. Cl. H04W 74/0833; H04L 5/14; H04W 8/22; H04W 74/08

(52) U.S. Cl. CPC H04W 74/0833; H04L 5/14; H04W 8/22; H04W 74/0891

(57) ABSTRACT

Methods, systems, and devices for wireless communications are described. A user equipment (UE) may support switching to another type of random access occasion (RO) to another type of RO based on a boundary of an association period. In some examples, the UE may support switching between the two types of ROs based on the boundary of an association pattern period. In some examples, the UE may support switching between the two types of ROs based on a synchronization signal block (SSB) to RO mapping cycle. In some examples, the UE may support switching between the types of ROs based on a time threshold from a latest transmission.

### CROSS REFERENCES

The present Application for Patent claims benefit of U.S. Provisional Patent Application No. 63/684,792 by ABOTABL et al., entitled “RANDOM ACCESS OCCASION TYPE SWITCHING TIMELINES FOR SUBBAND FULL DUPLEX DEVICES,” filed Aug. 19, 2024, assigned to the assignee hereof, and expressly incorporated herein.

### FIELD OF TECHNOLOGY

The following relates to wireless communications, including random access occasion type switching timelines for subband full duplex devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation, transmitting one or more random access messages via one or more random access occasions of the first set of random access occasions during a first time period, switching from the first type of random access occasions to the second type of random access occasions, and transmitting one or more random access messages via one or more random access occasions of the second set of random access occasions during a second time period in accordance with the switch.

A UE for wireless communications is described. The UE may include one or more memories storing processor executable code, and one or more processors coupled with the one or more memories. The one or more processors may individually or collectively be operable to execute the code to cause the UE to receive first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation, transmit one or more random access messages via one or more random access occasions of the first set of random access occasions during a first time period, switch from the first type of random access occasions to the second type of random access occasions, and transmit one or more random access messages via one or more random access occasions of the second set of random access occasions during a second time period in accordance with the switch.

Another UE for wireless communications is described. The UE may include means for receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation, means for transmitting one or more random access messages via one or more random access occasions of the first set of random access occasions during a first time period, means for switching from the first type of random access occasions to the second type of random access occasions, and means for transmitting one or more random access messages via one or more random access occasions of the second set of random access occasions during a second time period in accordance with the switch.

A non-transitory computer-readable medium storing code for wireless communications is described. The code may include instructions executable by one or more processors to receive first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation, transmit one or more random access messages via one or more random access occasions of the first set of random access occasions during a first time period, switch from the first type of random access occasions to the second type of random access occasions, and transmit one or more random access messages via one or more random access occasions of the second set of random access occasions during a second time period in accordance with the switch.

Some examples of the method, user equipment (UEs), and non-transitory computer-readable medium described herein may further include operations, features, means, or instructions for skipping one or more random access occasions of the second set of random access occasions during the first time period based on selecting the first type of random access occasions and skipping one or more random access occasions of the first set of random access occasions during the second time period based on switching from the first type of random access occasions to the second type of random access occasions.

In some examples of the method, user equipment (UEs), and non-transitory computer-readable medium described herein, the first time period includes a first association period corresponding to a first mapping between first synchronization signal blocks (SSBs) and a first set of multiple random access occasions of the first set of random access occasions, the second set of random access occasions, or both, and the second time period includes a second association period corresponding to a second mapping between second SSBs and a second set of multiple random access occasions of the first set of random access occasions, the second set of random access occasions, or both.

In some examples of the method, user equipment (UEs), and non-transitory computer-readable medium described herein, the first time period includes a first association pattern period including a first set of association periods, and the second time period includes a second association pattern period including a second set of association periods.

Some examples of the method, user equipment (UEs), and non-transitory computer-readable medium described herein may further include operations, features, means, or instructions for receiving an indication of a threshold quantity of random access transmissions, where a quantity of the one or more random access messages transmitted via the first set of random access occasions during the first time period satisfies the threshold quantity of random access transmissions.

Some examples of the method, user equipment (UEs), and non-transitory computer-readable medium described herein may further include operations, features, means, or instructions for refraining from transmitting any additional random access messages until expiration of the first time period, where switching from the first type of random access occasions to the second type of random access occasions may be based on expiration of the first time period.

Some examples of the method, user equipment (UEs), and non-transitory computer-readable medium described herein may further include operations, features, means, or instructions for transmitting one or more additional random access messages exceeding the threshold quantity of random access transmissions prior to expiration of the first time period, where switching from the first type of random access occasions to the second type of random access occasions may be based on expiration of the first time period.

Some examples of the method, user equipment (UEs), and non-transitory computer-readable medium described herein may further include operations, features, means, or instructions for initiation the switching from the first type of random access occasions to the second type of random access occasions prior to expiration of the first time period based on the quantity of the one or more random access messages transmitted via the first set of random access occasions during the first time period satisfying the threshold quantity of random access transmissions.

Some examples of the method, user equipment (UEs), and non-transitory computer-readable medium described herein may further include operations, features, means, or instructions for initiating the first time period upon transmission of a first random access message via a random access occasion of the first type of random access occasions, resetting the first time period each time the UE transmits another random access message via a random access occasion of the first type of random access occasions, and refraining from transmitting random access messages via one or more random access occasions of the second type of random access occasions that occur within the first time period or the reset first time period.

Some examples of the method, user equipment (UEs), and non-transitory computer-readable medium described herein may further include operations, features, means, or instructions for switching from the first type of random access occasions to the second type of random access occasions may be based on expiration of the first time period subsequent to a most recent transmission of the one or more random access messages via the first set of random access occasions.

Some examples of the method, user equipment (UEs), and non-transitory computer-readable medium described herein may further include operations, features, means, or instructions for transmitting capability information indicating that the UE may be capable of switching between the first type of random access occasions or the second type of random access occasions, where performing the switching may be based on transmitting the capability information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access occasion type switching timelines for subband full duplex devices in accordance with one or more aspects of the present disclosure.

FIG. 2 shows an example of a wireless communications system that supports random access occasion type switching timelines for subband full duplex devices in accordance with one or more aspects of the present disclosure.

FIG. 3 shows an example of a timeline that supports random access occasion type switching timelines for subband full duplex devices in accordance with one or more aspects of the present disclosure.

FIG. 4 shows an example of a timeline that supports random access occasion type switching timelines for subband full duplex devices in accordance with one or more aspects of the present disclosure.

FIG. 5 shows an example of a timeline that supports random access occasion type switching timelines for subband full duplex devices in accordance with one or more aspects of the present disclosure.

FIG. 6 shows an example of a timeline that supports random access occasion type switching timelines for subband full duplex devices in accordance with one or more aspects of the present disclosure.

FIG. 7 shows an example of a process flow that supports random access occasion type switching timelines for subband full duplex devices in accordance with one or more aspects of the present disclosure.

FIGS. 8 and 9 show block diagrams of devices that support random access occasion type switching timelines for subband full duplex devices in accordance with one or more aspects of the present disclosure.

FIG. 10 shows a block diagram of a communications manager that supports random access occasion type switching timelines for subband full duplex devices in accordance with one or more aspects of the present disclosure.

FIG. 11 shows a diagram of a system including a device that supports random access occasion type switching timelines for subband full duplex devices in accordance with one or more aspects of the present disclosure.

FIGS. 12 through 14 show flowcharts illustrating methods that support random access occasion type switching timelines for subband full duplex devices in accordance with one or more aspects of the present disclosure.

### DETAILED DESCRIPTION

A user equipment (UE) may perform a random access procedure. In some examples, the UE may receive downlink signaling (e.g., synchronization signal physical broadcast channel (PBCH) blocks (SSBs)) via one or more beams, and may select a random access occasion (RO) based thereon for transmission of a first random access message (e.g., a random access preamble). In some examples, the network entity may configure the UE with a first set of ROs and a second set of ROs. The second set of ROs may be subband full duplex (SBFD) ROs located in an uplink subband of an SBFD time interval (e.g., slot). The first set of ROs may be non-SBFD ROs located in uplink or flexible slots. For an SBFD aware UE, the SBFD ROs may be invalid (e.g., or the UE may not be configured with or have access to the second set of ROs). For an SBFD aware UE, the UE may be capable of selecting either a non-SBFD RO or an SBFD RO via which to transmit a random access preamble. Such a selection may be performed based on timing constraints, or transmit power constraints. However, if multiple UEs make their own determinations regarding selection of ROs, then multiple or many UEs may simultaneously make the same selection, which may result in random access collisions, failed random access procedures or delayed random access procedures, inefficient use of available system resources (e.g., if most or all UEs in a geographical area select the same type of ROs when other types of ROs are available), increased system latency, and decreased user experience. Further, if a UE switches back and forth between types of ROs without any limitations over time, the UE may experience significantly increased overhead, increased congestion, inconsistency in random access attempts, and increased system latency.

Techniques described herein support RO selection, and switching between types of ROs, according to one or more timing constraints or rules. In some examples, the UE may support switching to another type of RO based on a boundary of an association period (e.g., the UE may send retransmissions via the initially selected type of RO during an association period, and may switch to the other type of RO during a next association period if the random access procedure is still unsuccessful). In some examples, the UE may support switching between the two types of ROs based on the boundary of an association pattern period (e.g., a set of multiple association periods). In some examples, the UE may support switching between the two types of ROs based on an SSB to RO mapping cycle. In some examples, the UE may support switching between the types of ROs based on a time threshold from a latest transmission (e.g., if the time from a lates transmission exceeds a threshold time duration, then the UE may switch to another type of RO, otherwise the UE may only select ROs of the same type as the initial type of RO, in which case the time duration may be reset). In some examples, the UE may perform switching without reference to any time boundaries (e.g., switching may occur regardless of timing constraints).

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to random access occasion type switching timelines for subband full duplex devices.

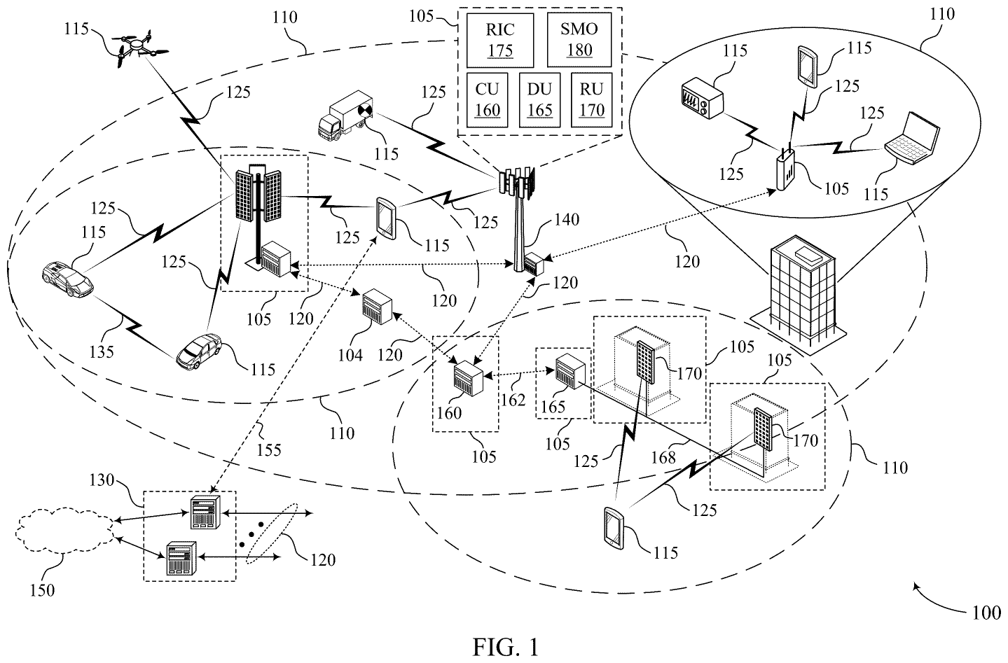

FIG. 1 shows an example of a wireless communications system 100 that supports random access occasion type switching timelines for subband full duplex devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may support switching to another type of RO to another type of RO based on a boundary of an association period. In some examples, the UE 115 may support switching between the two types of ROs based on the boundary of an association pattern period. In some examples, the UE 115 may support switching between the two types of ROs based on a SSB to RO mapping cycle. In some examples, the UE 115 may support switching between the types of ROs based on a time threshold from a latest transmission.

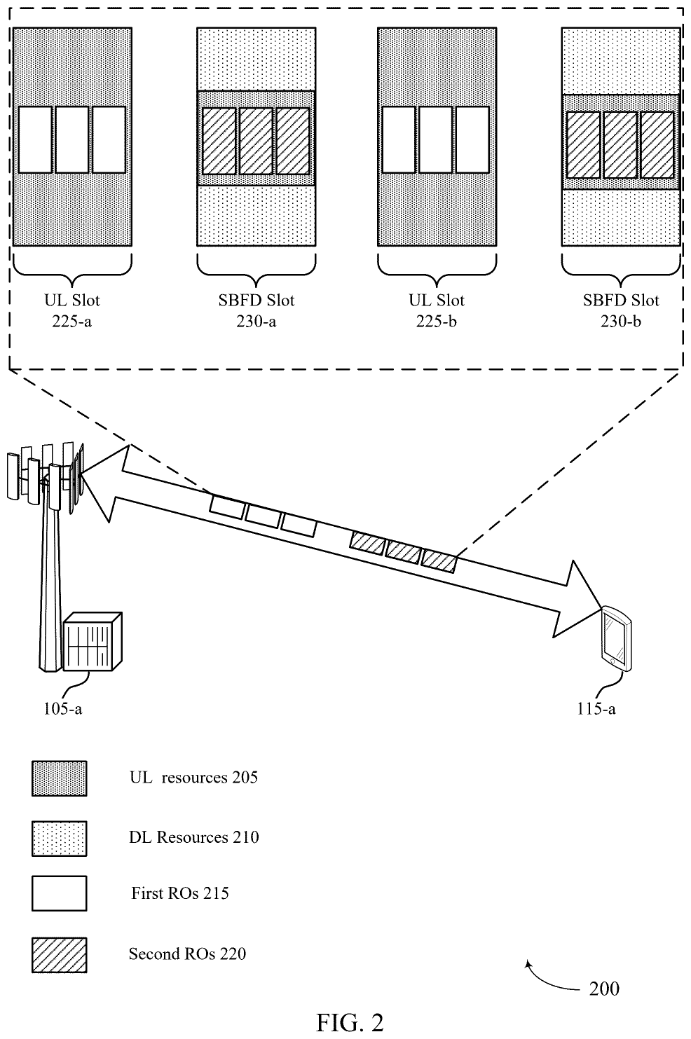

FIG. 2 shows an example of a wireless communications system 200 that supports random access occasion type switching timelines for subband full duplex devices in accordance with one or more aspects of the present disclosure. The timeline 300 may implement, or be implemented by, aspects of the wireless communications system 100, the wireless communications system 200, or any combination thereof. For example, a UE (e.g., a UE 115) and a network entity (e.g., a network entity 105), which may be examples of corresponding devices described with reference to FIGS. 1-2, may communicate in accordance with the timeline 300.

The wireless communications system may support random access communications. For example, the UE 115-a may monitor for one or more synchronization signal physical broadcast channel blocks (SSBs) and may select a corresponding RO via which to transmit a first random access message (e.g., RO). Some ROs (e.g., first ROs 215) may be located in uplink or flexible slots (e.g., UL slots 225). Some ROs (e.g., second ROs 220) may be located in UL resources 205 (e.g., an uplink subband) in an SBFD slots 230 (e.g., which includes both UL resources 205 and DL resources 210). In some examples, first ROs 215 may be referred to as legacy ROs, and second ROs 220 maybe referred to as SBFD ROs. Some wireless devices may not support SBFD modes of operation, and may only be capable of transmitting random access signaling via the first ROs 215. Other UEs (e.g., SBFD-aware UEs) may be capable of transmitting random access signaling via the first ROs 215, and via the second ROs 220.

In some examples (e.g., where the UE 115-a and the network entity 105-a are operating in a connected mode, such as an RRC connected UE), the wireless communications system may support one or more configurations of the ROs. In some examples, the UE 115-a may receive control signaling including a single shared physical random access channel (PRACH) configuration indicating both the first ROs 215, and additional second ROs 220. A UE that is not capable of supporting the SBFD operations may consider the second ROs 220 (e.g., SBFD ROs) invalid. The UE 115-a may be an SBFD-aware UE, and may consider the second ROs 220 as valid ROs. For example, a single RACH configuration using a single PRACH configuration index may indicate both the first ROs 215 and the second ROs 220. Or, in some examples, two different RACH configuration with separate PRACH configuration indices may be utilized to configure the first ROs 215, and the second ROs 220. In some examples, the UE 115-a may receive a first configuration of the first ROs 215, and a second configuration (e.g., an SBFD-dedicated PRACH configuration) of the second ROs 220. In either scenario, the UE 115-a may be capable of selecting an RO of the first ROs 215, or an RO of the second RO 220 for transmitting a random access message.

The UE may select a first RO 215 or a second RO 220 based on one or more conditions or scenarios. For example, at a point in time after the UL slot 225-a, the next available (e.g., soonest occurring) RO may be an SBFD RO in the SBFD slot 230-a (or a non-SBFD RO in the UL slot 225-b may occur prior to the SBFD ROs in the SBFD slot 230-b). However, in the case of power control, it may be more beneficial to transmit a threshold transmit power, or a target received power, among other examples (e.g., even if the UE 115-a would need to wait longer for an RO that would satisfy some constraints). Further, if multiple UEs 115 served the network entity 105, selection of ROs by individual UEs may not result in optimal traffic or overall RO utilization for the wireless communications system 100. For example, SBFD-aware UEs may indicate SBFD capabilities to the network entity by transmitting random access signaling via SBFD ROs. If a large quantity (e.g., or all) SBFD aware UEs 115 in a geographic area select the next available ROs (e.g., second ROs 220 in the SBFD slot 230-a) or automatically select SBFD ROs in the SBFD slot 230-a to indicate SBFD capabilities, then there is a high likelihood of RACH collisions occurring, resulting in failed random access procedures, increased delays in random access procedures, increased system latency, increased system congestion, and less efficient use of available ROs. Such issues may be exacerbated by initial RO selection and additional RO selection in the case of a failed initial random access transmission or a failed random access procedures (e.g., multiple failed random access transmissions). Further, if the UEs 115 select one type of RO, then the UEs 115 may subsequent switch from one type of RO to another type of RO (e.g., from SBFD ROs to non-SBFD ROs, or vice versa). However, UEs 115 may random switch between types of ROs, resulting in increased overhead, or may fail to switch from one type of RO to another type of RO soon enough to improve efficiency of random access procedures.

It may instead be beneficial for the UE to switch between types of ROs according to one or more rules or constraints to ensure more efficient use of available system resources, more balanced selection of first ROs 215 and second ROs 220 by various UEs 115 over time. Such procedures may result in increased throughput, more efficient random access procedures, more efficient use of available system resources including ROs, decreased system latency, and improved user experience. Further, such techniques may apply to initial random access transmissions and RO selection for subsequent random access transmissions (e.g., in the case of failed initial random access transmission or a failed random access procedures).

According to techniques described herein, a UE 115 may select an RO (e.g., an SBFD RO or a non-SBFD RO) and may transmit a first random access message (e.g., a random access preamble) via the selected random access message. In some examples, the initial random access transmission may fail (e.g., a random access response message may not be received) In such examples, the UE may prepare to send a PRACH retransmission (e.g., a retransmission of a random access preamble). The UE 115 may select another RO for the retransmission. In some examples, as described herein, the UE 115-a may support switching between PRACH resource types (e.g., between SBFD ROs and non-SBFD ROs) based on one or more timelines. For example, the UE may send one or more retransmission of the random access message via the initially selected type of RO during a first time period (e.g., a first duration, or while a first timer runs), and may switch to the other type of RO during a second time period (e.g., upon expiration of the first time period). For instance, the UE 115-a may support switching to another type of RO based on a boundary of an association period (e.g., the UE may send retransmissions via the initially selected type of RO during an association period, and may switch to the other type of RO during a next association period if the random access procedure is still unsuccessful). In some examples, the UE 115-a may support switching between the two types of ROs based on the boundary of an association pattern period (e.g., a set of multiple association periods). In some examples, the UE 115-a may support switching between the two types of ROs based on an SSB to RO mapping cycle. In some examples, the UE 115-b may support switching between the types of ROs based on a time threshold from a latest transmission (e.g., if the time from a lates transmission exceeds a threshold time duration, then the UE 115-a may switch to another type of RO, otherwise the UE 115-a may only select ROs of the same type as the initial type of RO, in which case the time duration may be reset). In some examples, the UE 115-a may perform switching without reference to any time boundaries (e.g., switching may occur regardless of timing constraints).

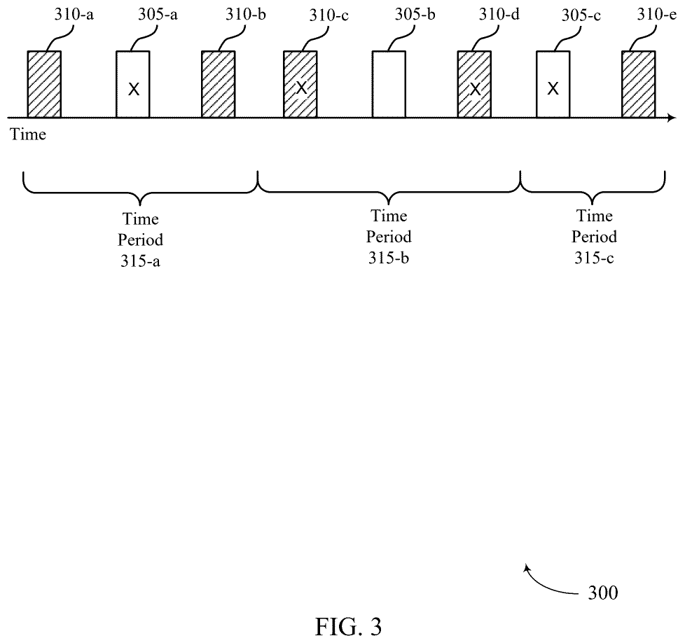

FIG. 3 shows an example of a timeline 300 that supports random access occasion type switching timelines for subband full duplex devices in accordance with one or more aspects of the present disclosure. In some examples, a UE may support switching between a first type of ROs and a second type of ROs based on a boundary of an association period. For example, the UE may receive control signaling indicating a first set of ROs and a second set of ROs (e.g., via a single configuration or via two separate configurations). For instance, the network entity may configure the UE with SBFD ROs 310 and non-SBFD ROs 305. During each association period (e.g., a time period 315 corresponding to a mapping between ROs and SSBs) the UE may not support switching between the RO types. For instance, the UE may transmit a first random access preamble via an SBFD RO 310-a.

In some examples, a UE may support switching between a first type of ROs and a second type of ROs based on a boundary of an association period. For example, the UE may receive control signaling indicating a first set of ROs and a second set of ROs (e.g., via a single configuration or via two separate configurations). For instance, the network entity may configure the UE with SBFD ROs 310 and non-SBFD ROs 305. During each association period (e.g., a time period 315 corresponding to a mapping between ROs and SSBs) the UE may not support switching between the RO types. For instance, the UE may transmit a first random access preamble via an SBFD RO 310-a.

During the time period 315-a, the UE may refrain from transmitting any retransmissions of the random access preamble via ROs 305 (e.g., the UE may skip the RO 305-a, but may send a retransmission via the RO 310-b). Upon expiration of the first association period (e.g., the time period 315-a), the UE may support switching from the SBFD ROs 310 to the non-SBFD ROs 305. In such examples, the UE may transmit a random access message (e.g., may send a retransmission of a random-access preamble) via one or more non-SBFD ROs 305 (e.g., via the non-SBFD RO 305-b). The UE may refrain from transmitting random access signaling (e.g., retransmissions of the random access preamble) via SBFD ROs 310 (e.g., via the SBFD RO 310-c and the SBFD RO 310-d) during the time period 315-b.

If a random access procedure is still incomplete (e.g., the UE has transmitted the random access preamble one or more times, but has still failed to receive a random access response message), then the UE may transmit one or more additional random access messages (e.g., preambles) via SBFD ROs 310 during the time period 315-c. That is, the UE may support switching to the other type of random access message after the time period 315-b. In such examples, the UE may skip the non-SBFD RO 305-c and may transmit a random access message via the SBFD RO 310-e. Similar procedures may be implemented if the UE initially selects a non-SBFD RO 305 (e.g., during the time period 315-a), in which case the UE may refrain from transmitting random access signaling via the non-SBFD ROs 310 during the time period 315-a, and may switch from the non-SBFD ROs 305 during the time period 315-a to the SBFD ROs 310 during the time period 315-b.

In some examples, one or more rules (e.g., whether switching between types of ROs is supported, whether restrictions are applied for switching from the first type of RO to the second type of RO, or from the second type of RO to the first type of RO, or both), or a configuration of the time period 315 (e.g., a timer value, a duration of the time period 315, rules regarding the association periods) may be defined in one or more standards documents, or may be indicated via one or more control messages.

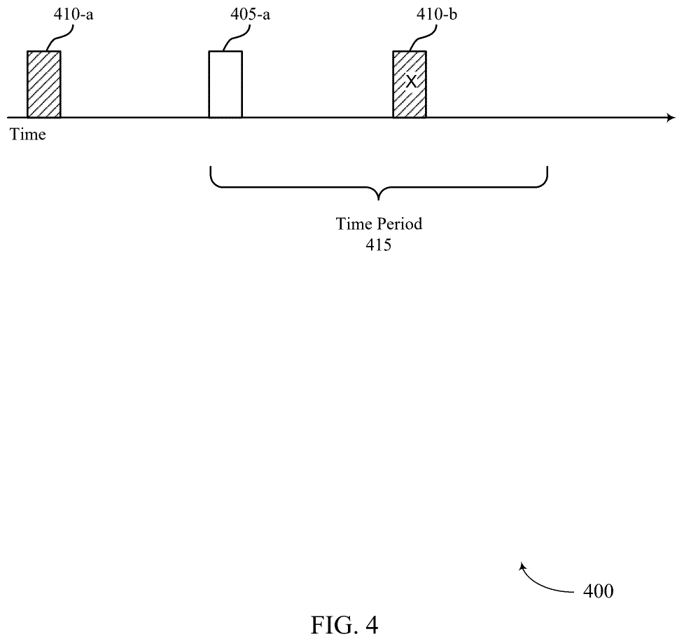

FIG. 4 shows an example of a timeline 400 that supports random access occasion type switching timelines for subband full duplex devices in accordance with one or more aspects of the present disclosure. The timeline 400 may implement, or be implemented by, aspects of the wireless communications system 100, the wireless communications system 200, the timeline 300, or any combination thereof. For example, a UE (e.g., a UE 115) and a network entity (e.g., a network entity 105), which may be examples of corresponding devices described with reference to FIGS. 1-3, may communicate in accordance with the timeline 400.

In some examples, the UE may support switching between types of ROs based on a boundary between an association pattern period. For example, the UE may transmit one or more retransmissions of a random access message (e.g., preamble), and may refrain from switching from one type of RO to another during an association pattern period (e.g., but may switch to another type of RO during a next association pattern period if the random access procedure has not yet been successful).

In some examples, the switching timeline may be different based on the switching direction. For example, switching from a first RO type to a second RO type may be supported under a first set of conditions or rules (e.g., the switching may be supported without restriction), but switching from the second RO type to the first RO type may be supported under a second set of conditions or rules (e.g., the switching may be supported only after a time period 415). For example, switching from SBFD PRACH resources to non-SBFD PRACH resources may not be restricted, but switching from the non-SBFD resources to the SBFD PRACH resources may be restricted according to the time period 415. For instance, the UE may select a first type of ROs (e.g., SBFD ROs 410), and my transmit a random access preamble (e.g., an initial transmission or a retransmission) via the SBFD RO 410-a. For a next retransmission of the random access preamble, the UE may switch to the non-SBFD RO 405-a (e.g., without restriction, or without waiting for a time period to expire). The UE may transmit the retransmission via the non-SBFD RO 405-a. However, according to the one or more rules or restrictions, the UE may refrain from transmitting another retransmission via the SBFD RO 410-b (e.g., the UE may not switch back to the SBFD ROs 410 from the non-SBFD ROs 405 during the time period 415). The UE may send one or more additional retransmissions via non-SBFD ROs 405 during the time period 415 based on the switching. However, the UE may refrain from transmitting any retransmissions via SBFD ROs during the time period 415. After the time period 415, the UE may switch back to SBFD ROs 410 (e.g., if the random access procedure is not yet completed).

In some examples, one or more rules (e.g., whether switching between types of ROs is supported, whether restrictions are applied for switching from the first type of RO to the second type of RO, or from the second type of RO to the first type of RO, or both), a configuration of the time period 415 (e.g., a timer value, a duration of the time period 415, rules regarding the association pattern period) may be defined in one or more standards documents, or may be indicated via one or more control messages.

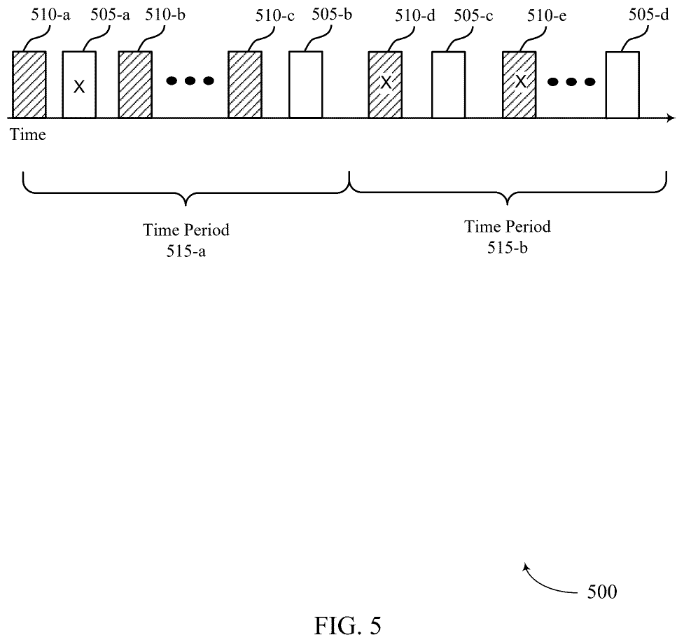

FIG. 5 shows an example of a timeline 500 that supports random access occasion type switching timelines for subband full duplex devices in accordance with one or more aspects of the present disclosure. The timeline 500 may implement, or be implemented by, aspects of the wireless communications system 100, the wireless communications system 200, the timeline 300, the timeline 400, or any combination thereof. For example, a UE (e.g., a UE 115) and a network entity (e.g., a network entity 105), which may be examples of corresponding devices described with reference to FIGS. 1-4, may communicate in accordance with the timeline 500.

In some examples, the UE may support switching between types of ROs based on a threshold quantity of supported transmissions. For example, the network entity may configure the UE with a threshold quantity of transmissions (e.g., or retransmissions) in case of unsuccessful random access transmissions or failed random access procedures. For example, the UE may be configured with a threshold quantity of random access preamble transmissions (e.g., four transmissions, among other examples) after which the random access procedure is considered to have failed, or after which the UE is permitted to switch to another random access type. In some examples, the UE may only be permitted to switch from a first RO type to a second RO type after a first time period 515-a (e.g., a first timer duration, a first association period, association partner period, SSB-RO mapping cycle, time period, etc.). In some examples, the UE may transmit the threshold quantity of transmissions prior to expiration of the first time period 515-a. For example, the UE may be ready to fall back from SBFD ROs 510 to the non-SBFD ROs 505 prior to expiration of the time period 515-a (e.g., the UE may have already transmitted the threshold quantity of random access preambles but may be unable to switch to non-SBFD ROs 505 until the time period 515-b).

In some examples, if the UE has already transmitted the threshold quantity of random access transmissions via an initially selected type of ROs, then the UE may refrain from transmission of another random access transmission until the switching time boundary has occurred (e.g., at which point the UE may perform the switching, such as falling back to non-SBFD ROs). For instance, the UE may be select the SBFD RO 510-a, and may transmit one or more retransmissions of a random access message via SBFD ROs 510 during the time period 515-a. The UE may skip non-SBFD ROs 505 during the time period 515-a (e.g., the UE may transmit random access signaling via the SBFD RO 510-a and the SBFD RO 510-b and may refrain from transmitting a random access retransmission via the non-SBFD RO 505-a). If the UE reaches the threshold quantity of random access transmissions or retransmissions prior to the SBFD RO 510-c, the UE may refrain from sending any addition random access message transmissions until the time period 515-b, at which time the UE may switch to the non-SBFD ROs 505 (e.g., the UE may refrain from transmitting random access retransmissions via the SBFD RO 510-d and the SBFD RO 510-e, and may instead send random access message transmissions or retransmissions via the non-SBFD RO 505-c, the non-SBFD RO 505-d, or both).

In some examples, if the UE has already transmitted the threshold quantity of random access transmissions via an initially selected type of ROs, then the UE may ignore the threshold quantity of transmission attempts until the switching boundary is reached. For instance, the UE may be select the SBFD RO 510-a, and may transmit one or more retransmissions of a random access message via SBFD ROs 510 during the time period 515-a. The UE may skip non-SBFD ROs 505 during the time period 515-a (e.g., the UE may transmit random access signaling via the SBFD RO 510-a and the SBFD RO 510-b and may refrain from transmitting a random access retransmission via the non-SBFD RO 505-a). If the UE reaches the threshold quantity of random access transmissions or retransmissions prior to the SBFD RO 510-c, the UE may send one or more additional random access transmissions via available SBFD ROs 510 during the time period 515-a (e.g., the UE may send another random access message transmission via the SBFD RO 510-c even if the threshold quantity of transmission has already been reached or exceeded). The UE may continue to send random access message transmissions via any available SBFD ROs 510 during the time period 515-a. In cases where ethe random access procedure is still unsuccessful upon expiration of the time period 515-a, the UE may switch RO types (e.g., may switch from the SBFD ROs 510 to the non-SBFD ROs 505) for the next time period 515-b (e.g., during which time the UE may transmit random access message via the non-SBFD RO 505-c, the non-SBFD RO 505-d, or both).

In some examples, if the UE has already transmitted the threshold quantity of random access transmissions via an initially selected type of ROs, then the UE may ignore the boundary of the switching time, and switch RO types prior to the switching boundary. For instance, the UE may be select the SBFD RO 510-a, and may transmit one or more retransmissions of a random access message via SBFD ROs 510 during the time period 515-a. The UE may skip non-SBFD ROs 505 during at least a first portion of the time period 515-a (e.g., the UE may transmit random access signaling via the SBFD RO 510-a and the SBFD RO 510-b and may refrain from transmitting a random access retransmission via the non-SBFD RO 505-a). If the UE reaches the threshold quantity of random access transmissions or retransmissions prior to the SBFD RO 510-c, the UE may switch from RO types early (e.g. may switch from the SBFD ROs 510 to the non-SBFD ROs 505 prior to the time period 515-b). For example, if the UE has already transmitted the threshold quantity of random access transmissions prior to expiration of the time period 515-a, then the UE may switch from the SBFD ROs 510 to the non-SBFD ROs 505, and may transmit a random access message via the non-SBFD RO 505-b.

In some examples, one or more rules (e.g., whether switching between types of ROs is supported, whether restrictions are applied for switching from the first type of RO to the second type of RO, or from the second type of RO to the first type of RO, or both), a configuration of the time period 515 (e.g., a timer value, a duration of the time period 515, rules regarding the association pattern period) may be defined in one or more standards documents, or may be indicated via one or more control messages.

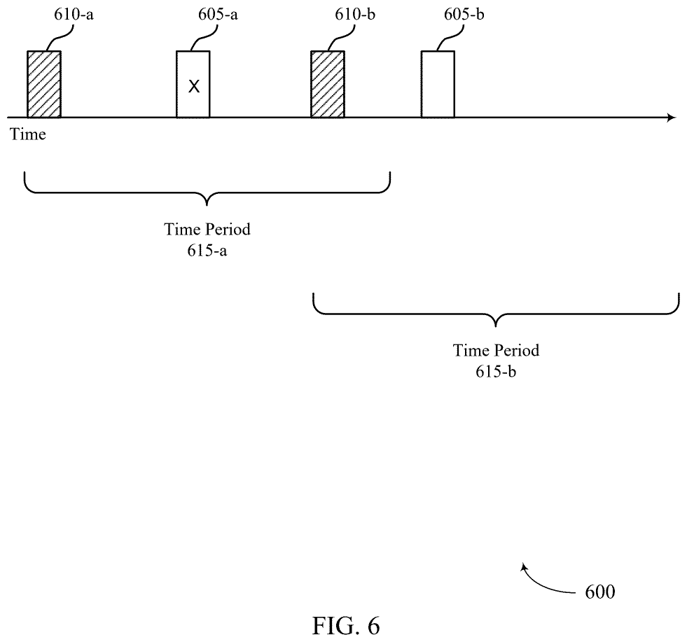

FIG. 6 shows an example of a timeline 600 that supports random access occasion type switching timelines for subband full duplex devices in accordance with one or more aspects of the present disclosure. The timeline 600 may implement, or be implemented by, aspects of the wireless communications system 100, the wireless communications system 200, the timeline 300, the timeline 400, the timeline 500, or any combination thereof. For example, a UE (e.g., a UE 115) and a network entity (e.g., a network entity 105), which may be examples of corresponding devices described with reference to FIGS. 1-5, may communicate in accordance with the timeline 600.

In some examples, the UE may support switching between types of ROs based on a time threshold from a latest transmission (e.g., if a time from a latest PRACH transmission exceeds a threshold time duration, then the UE may switch from one type of ROs to another, otherwise, the UE may not be permitted to perform the switching). For example, the UE may select the SBFD ROs 610, and begin sending one or more transmissions or retransmissions via SBFD ROs 610. The UE may transmit a random access transmission via the SBFD RO 610-a. During the time period 615-a (e.g., a threshold quantity of time from the transmission at the SBFD RO 610-a), the UE may not be permitted to switch from the SBFD ROs 610 to the non-SBFD ROs 605. In such examples, the UE may skip the non-SBFD RO 605-a. Upon expiration of the time period 615-a, the UE may be permitted to switch from the SBFD ROs 610 to the non-SBFD ROs 605. If the UE also skips the SBFD RO 610-b (e.g., which occurs within the time period 615-a), then the UE may switch to the non-SBFD ROs 605 after the time period 615-a, and may send a retransmission of the random access message via the non-SBFD RO 605-b. If the UE sends another random access transmission via the SBFD RO 610-b (e.g., which occurs within the time period 615-a), then the time period may be reset (e.g., the time period 615-b may be initiated upon transmission via the SBFD RO 610-b). In such examples, the UE may not be permitted to switch from the SBFD ROs 610 to the non-SBFD ROs during the time period 615-b, in which case the UE may skip the non-SBFD RO 605-b.

In some examples, one or more rules (e.g., whether switching between types of ROs is supported, whether restrictions are applied for switching from the first type of RO to the second type of RO, or from the second type of RO to the first type of RO, or both), a configuration of the time period 615 (e.g., a timer value, a duration of the time period 615, rules regarding the association pattern period) may be defined in one or more standards documents, or may be indicated via one or more control messages.

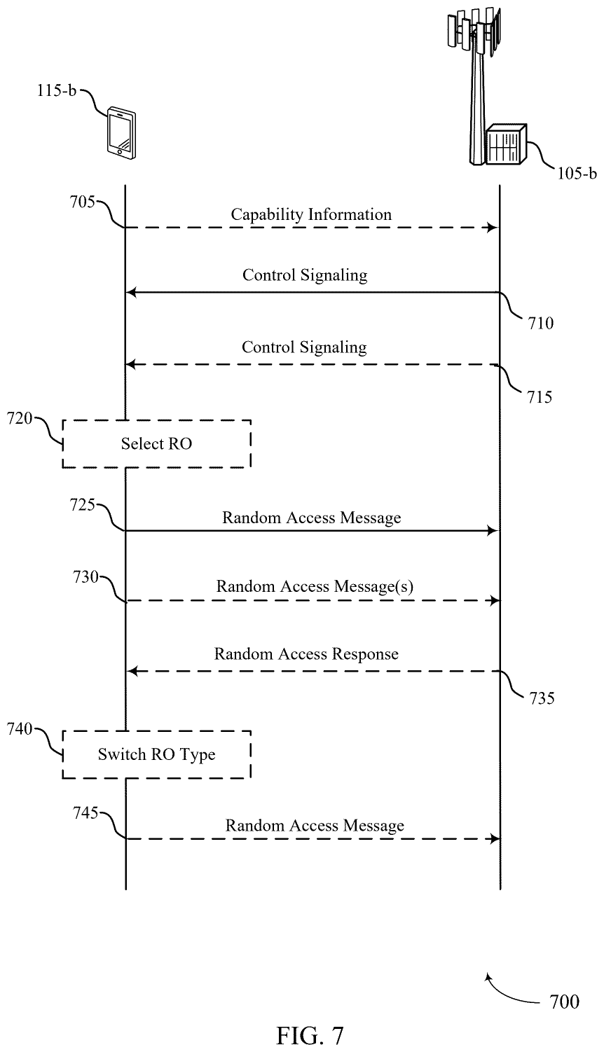

FIG. 7 shows an example of a process flow 700 that supports random access occasion type switching timelines for subband full duplex devices in accordance with one or more aspects of the present disclosure. The process flow 700 may implement, or be implemented by, aspects of the wireless communications system 100, the wireless communications system 200, the timeline 300, the timeline 400, the timeline 500, the timeline 600, or any combination thereof. For example, the process flow 700 may include a UE 115-b and a network entity 105-b, which may be examples of corresponding devices described with reference to FIGS. 1-6.

At 710, the UE 115-b may receive control signaling indicating one or more RO configurations. For example, the first control signaling may indicate a first set of ROs. The first set of ROs may be located in uplink or flexible slots or symbols, and may correspond to a half duplex mode of operation. In some examples, the first control signaling may indicate a second set of ROs. The second set of ROs may be SBFD ROs, and may be associated with a SBFD mode of operation. In some examples, the UE 115-b may receive a single configuration of both the first and second sets of ROs (e.g., at 710). In some examples, the UE 115-b may receive a first configuration (e.g., a first control message at 710) indicating the first set of ROs, and a second configuration (e.g., a second control message at 715) indicating the second set of ROs.

At 720, the UE 115-b may select an RO. The UE 115-b may select either a first RO from the first set of ROs (e.g., a legacy RO or non-SBFD RO) or a second RO from the second set of ROs (e.g., an SBFD RO).

At 725, the UE 115-b may transmit a first random access message (e.g., a random access preamble). The UE 115-b may transmit the random access message via the selected RO (e.g., either the first type of RO or the second type of RO).

Subsequent to transmission of the first random access message, in some examples, the UE 115-b may transmit one or more additional random access messages (e.g., at 735). For example, the UE 115-b may perform multiple PRACH attempts. In some examples, the UE 115-b may transmit multiple random access preambles (e.g., as part of a single PRACH attempt), and if no random access response message is received (e.g., within an amount of time or prior to expiration of a timer), the UE 115-b may determine that the PRACH attempt has failed.

The UE 115-b may select an RO for each PRACH transmission, each PRACH attempt, or a combination thereof. For example, at 730, the UE 115-b may perform one or more PRACH attempts. If the UE 115-b does not receive a random access response (e.g., at 735), the UE 115-b may transmit one or more retransmissions of the random access preamble.

In some examples, the UE 115-b may switch between SBFD ROs and non-SBFD ROs over time. For example, the UE 115-b may perform random access attempts (e.g., at 725 and 730), which may fail. The UE 115-b may switch RO types at 740 (e.g., if the UE 115-b does not successfully receive a random access response at 735). For instance, if the UE 115-b has selected SBFD ROs at 720 or at 730 and transmits random access preambles via the SBFD ROs during a first time period, then at 740 the UE 115-b may switch to non-SBFD ROs, and may transmit a random access message (e.g., a random access preamble) at 745 via the other type of RO during a second time period based on the switching. The UE may skip one or more ROs of the second set of ROs (e.g., non-SBFD ROs) during the first time period based on selecting the first type of RO, and may skip one or more ROs of the second set of ROs (e.g., SBFD ROs) during the second time period based on the switching.

In some examples (e.g., as described in greater detail with reference to FIG. 3), the first time period may be a first association period corresponding to a first mapping between first SSBs and a first set of ROs of the first set of ROs, the second set of ROs, or both, and the second time period may be a second association period corresponding to a second mapping between second SSBs and a second set of ROs of the first set of ROs, the second set of ROs, or both.

In some examples, the first time period may be a first association pattern period including a first set of association periods, and the second time period may be a second association pattern period including a second set of association periods. In some examples (e.g., as described in greater detail with reference to FIG. 4), the switching timeline may be based on (e.g., may be different for) a direction of the switching (e.g., from the first type of RO to the second type of RO, or vice versa).

In some example (e.g., as described in greater detail with reference to FIG. 5), the UE 115-b may receive an indication of a threshold quantity of random access transmissions (e.g., at 710, or at 715, or via additional control signaling). In some examples, a single threshold quantity of transmissions may be configured. In some examples, the UE 115-b may receive a first threshold quantity of transmission for the first type of ROs, and a second threshold quantity of transmission for the second type of RO. A quantity of the one or more random access transmissions (e.g., transmitted at 725 and 730) may satisfy the threshold quantity (e.g., the specific threshold quantity for the type of RO selected at 720). In some examples, the UE 115-b may refrain from transmitting any additional random access messages until expiration of the time period, and may then switch from the first type of RO to the second type of RO upon expiration of the first time period. In some examples, the UE 115-b may transmit one or more additional random access messages exceeding the threshold quantity prior to expiration of the first time period, and may then switch to the second type of RO upon expiration of the time period. In some examples, the UE 115-b may initiate the switch from the first type of RO to the second type of RO prior to expiration of the first time period (e.g., may ignore the switching boundary or the switching timeline) based at least in part on the quantity of the one or more random access messages transmitted via the first set of ROs during the first time period satisfying the threshold quantity of random access transmissions.

In some examples (e.g., as described in greater detail with reference to FIG. 6), the UE 115-b may initiate the first time period (e.g., a timer) upon transmission of a first random access message via an RO of the first type of RO (e.g., at 725). The UE 115-b may reset the first time period each time the UE transmits another random access message via an RO of the first type (e.g., at 730). The UE 115-b may refrain from transmitting random access messages via ROs of the second type that occur within the first time period (e.g., initiated at 725) or the reset time period (e.g., reset at 730). In such examples, switching from the first type of RO to the second type of RO (e.g., at 740) may be based on expiration of the first time period subsequent to a most recent transmission of the one or more random-access messages via the first set of ROs.

In some examples, the UE 115-b may report switching capability information to the network entity 105-b (e.g., at 705). The UE 115-b may indicate whether it supports switching between SBFD ROs and non-SBFD ROs, a direction of switching that is supported, a threshold (e.g., minimum) quantity of PRACH attempts supported before the UE 115-b can switch to the other type of RO, or a threshold (e.g., maximum) quantity of supported switches between the types of ROs within a PRACH procedure. In some examples, the UE 115-b may report one set of capabilities for the first type of ROs (e.g., non-SBFD ROs of the first set of ROs), and a second set of capabilities for the second type of ROs (e.g., SBFD ROs of the second set of ROs).

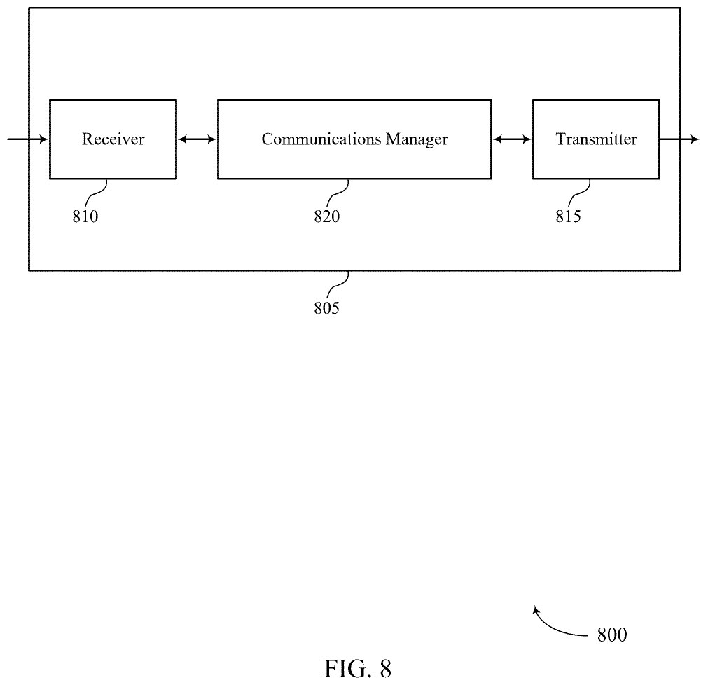

FIG. 8 shows a block diagram 800 of a device 805 that supports random access occasion type switching timelines for subband full duplex devices in accordance with one or more aspects of the present disclosure. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to random access occasion type switching timelines for subband full duplex devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to random access occasion type switching timelines for subband full duplex devices). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of random access occasion type switching timelines for subband full duplex devices as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The communications manager 820 is capable of, configured to, or operable to support a means for transmitting one or more random access messages via one or more random access occasions of the first set of random access occasions during a first time period. The communications manager 820 is capable of, configured to, or operable to support a means for switching from the first type of random access occasions to the second type of random access occasions. The communications manager 820 is capable of, configured to, or operable to support a means for transmitting one or more random access messages via one or more random access occasions of the second set of random access occasions during a second time period in accordance with the switch.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for random access procedures resulting in more efficient use of available system resources, more efficient random access signaling, reduced power consumption, and improved user experience.

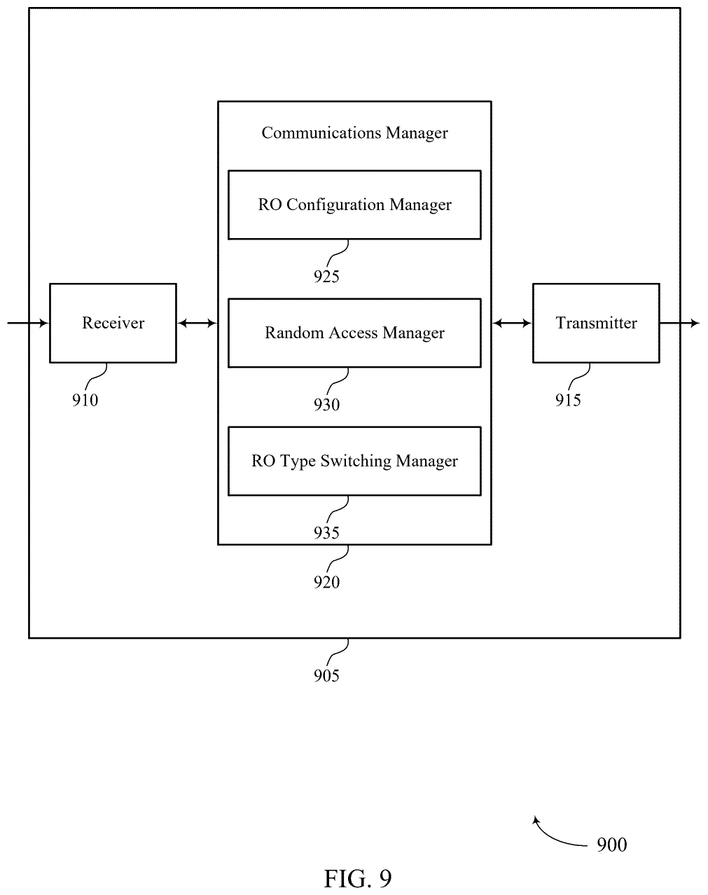

FIG. 9 shows a block diagram 900 of a device 905 that supports random access occasion type switching timelines for subband full duplex devices in accordance with one or more aspects of the present disclosure. The device 905 may be an example of aspects of a device 805 or a UE 115 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to random access occasion type switching timelines for subband full duplex devices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to random access occasion type switching timelines for subband full duplex devices). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of random access occasion type switching timelines for subband full duplex devices as described herein. For example, the communications manager 920 may include a RO configuration manager 925, a random access manager 930, a RO type switching manager 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The RO configuration manager 925 is capable of, configured to, or operable to support a means for receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The random access manager 930 is capable of, configured to, or operable to support a means for transmitting one or more random access messages via one or more random access occasions of the first set of random access occasions during a first time period. The RO type switching manager 935 is capable of, configured to, or operable to support a means for switching from the first type of random access occasions to the second type of random access occasions. The random access manager 930 is capable of, configured to, or operable to support a means for transmitting one or more random access messages via one or more random access occasions of the second set of random access occasions during a second time period in accordance with the switch.

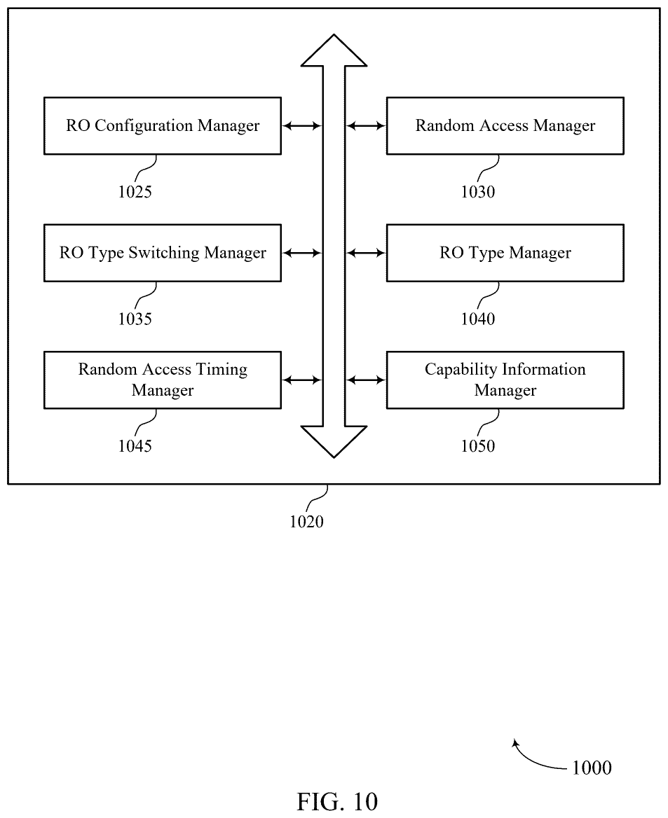

FIG. 10 shows a block diagram 1000 of a communications manager 1020 that supports random access occasion type switching timelines for subband full duplex devices in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of random access occasion type switching timelines for subband full duplex devices as described herein. For example, the communications manager 1020 may include a RO configuration manager 1025, a random access manager 1030, a RO type switching manager 1035, a RO type manager 1040, a random access timing manager 1045, a capability information manager 1050, or any combination thereof. Each of these components, or components or subcomponents thereof (e.g., one or more processors, one or more memories), may communicate, directly or indirectly, with one another (e.g., via one or more buses).

The communications manager 1020 may support wireless communications in accordance with examples as disclosed herein. The RO configuration manager 1025 is capable of, configured to, or operable to support a means for receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The random access manager 1030 is capable of, configured to, or operable to support a means for transmitting one or more random access messages via one or more random access occasions of the first set of random access occasions during a first time period. The RO type switching manager 1035 is capable of, configured to, or operable to support a means for switching from the first type of random access occasions to the second type of random access occasions. In some examples, the random access manager 1030 is capable of, configured to, or operable to support a means for transmitting one or more random access messages via one or more random access occasions of the second set of random access occasions during a second time period in accordance with the switch.

In some examples, the RO type manager 1040 is capable of, configured to, or operable to support a means for skipping one or more random access occasions of the second set of random access occasions during the first time period based on selecting the first type of random access occasions. In some examples, the RO type manager 1040 is capable of, configured to, or operable to support a means for skipping one or more random access occasions of the first set of random access occasions during the second time period based on switching from the first type of random access occasions to the second type of random access occasions.

In some examples, the first time period includes a first association period corresponding to a first mapping between first synchronization signal blocks (SSBs) and a first set of multiple random access occasions of the first set of random access occasions, the second set of random access occasions, or both, and the second time period includes a second association period corresponding to a second mapping between second SSBs and a second set of multiple random access occasions of the first set of random access occasions, the second set of random access occasions, or both.

In some examples, the first time period includes a first association pattern period including a first set of association periods, and the second time period includes a second association pattern period including a second set of association periods.

In some examples, the random access manager 1030 is capable of, configured to, or operable to support a means for receiving an indication of a threshold quantity of random access transmissions, where a quantity of the one or more random access messages transmitted via the first set of random access occasions during the first time period satisfies the threshold quantity of random access transmissions.

In some examples, the random access timing manager 1045 is capable of, configured to, or operable to support a means for refraining from transmitting any additional random access messages until expiration of the first time period, where switching from the first type of random access occasions to the second type of random access occasions is based on expiration of the first time period.

In some examples, the RO type switching manager 1035 is capable of, configured to, or operable to support a means for transmitting one or more additional random access messages exceeding the threshold quantity of random access transmissions prior to expiration of the first time period, where switching from the first type of random access occasions to the second type of random access occasions is based on expiration of the first time period.

In some examples, the RO type switching manager 1035 is capable of, configured to, or operable to support a means for initiation the switching from the first type of random access occasions to the second type of random access occasions prior to expiration of the first time period based on the quantity of the one or more random access messages transmitted via the first set of random access occasions during the first time period satisfying the threshold quantity of random access transmissions.

In some examples, the random access timing manager 1045 is capable of, configured to, or operable to support a means for initiating the first time period upon transmission of a first random access message via a random access occasion of the first type of random access occasions. In some examples, the random access timing manager 1045 is capable of, configured to, or operable to support a means for resetting the first time period each time the UE transmits another random access message via a random access occasion of the first type of random access occasions. In some examples, the random access timing manager 1045 is capable of, configured to, or operable to support a means for refraining from transmitting random access messages via one or more random access occasions of the second type of random access occasions that occur within the first time period or the reset first time period.

In some examples, switching from the first type of random access occasions to the second type of random access occasions is based on expiration of the first time period subsequent to a most recent transmission of the one or more random access messages via the first set of random access occasions.

In some examples, the capability information manager 1050 is capable of, configured to, or operable to support a means for transmitting capability information indicating that the UE is capable of switching between the first type of random access occasions or the second type of random access occasions, where performing the switching is based on transmitting the capability information.

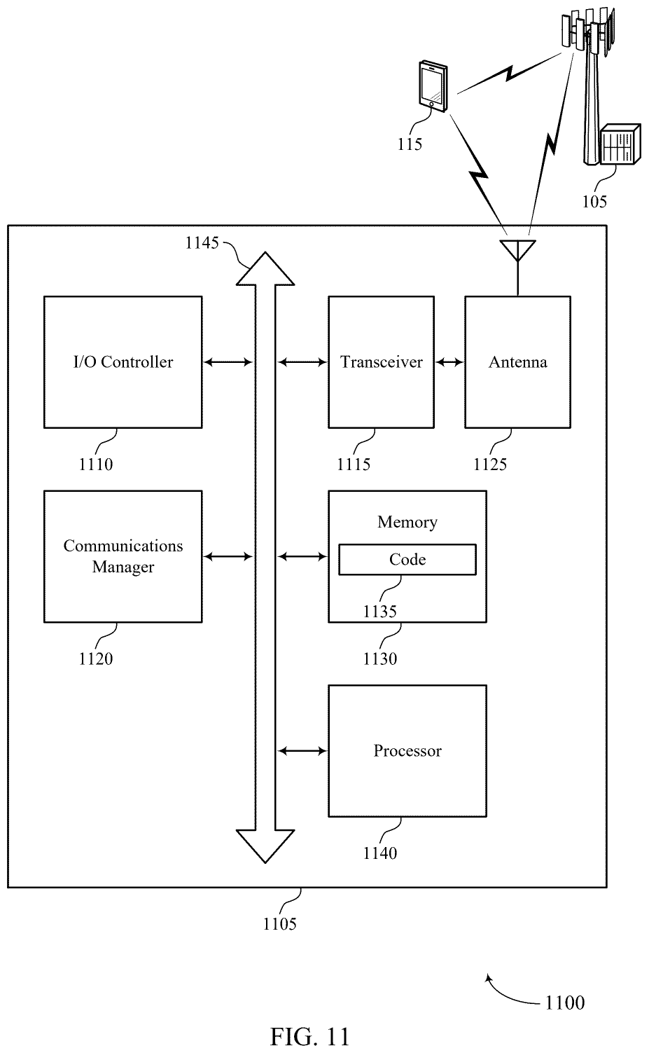

FIG. 11 shows a diagram of a system 1100 including a device 1105 that supports random access occasion type switching timelines for subband full duplex devices in accordance with one or more aspects of the present disclosure. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting random access occasion type switching timelines for subband full duplex devices). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

The communications manager 1120 may support wireless communications in accordance with examples as disclosed herein. For example, the communications manager 1120 is capable of, configured to, or operable to support a means for receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The communications manager 1120 is capable of, configured to, or operable to support a means for transmitting one or more random access messages via one or more random access occasions of the first set of random access occasions during a first time period. The communications manager 1120 is capable of, configured to, or operable to support a means for switching from the first type of random access occasions to the second type of random access occasions. The communications manager 1120 is capable of, configured to, or operable to support a means for transmitting one or more random access messages via one or more random access occasions of the second set of random access occasions during a second time period in accordance with the switch.

By including or configuring the communications manager 1120 in accordance with examples as described herein, the device 1105 may support techniques for random access procedures resulting in more efficient use of available system resources, more efficient random access signaling, reduced power consumption, improved coordination between devices, reduced latency, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of random access occasion type switching timelines for subband full duplex devices as described herein, or the at least one processor 1140 and the at least one memory 1130 may be otherwise configured to, individually or collectively, perform or support such operations.

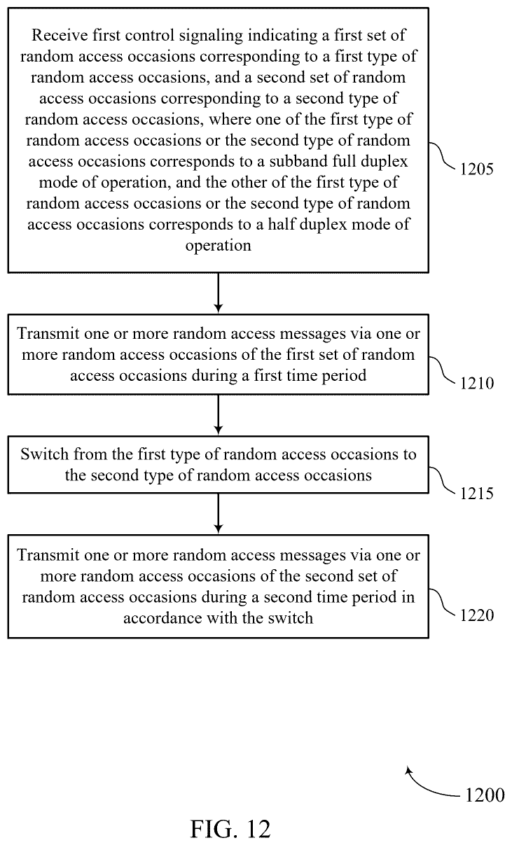

FIG. 12 shows a flowchart illustrating a method 1200 that supports random access occasion type switching timelines for subband full duplex devices in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The operations of 1205 may be performed in accordance with examples as disclosed herein. In some examples, aspects of the operations of 1205 may be performed by a RO configuration manager 1025 as described with reference to FIG. 10.

At 1210, the method may include transmitting one or more random access messages via one or more random access occasions of the first set of random access occasions during a first time period. The operations of 1210 may be performed in accordance with examples as disclosed herein. In some examples, aspects of the operations of 1210 may be performed by a random access manager 1030 as described with reference to FIG. 10.

At 1215, the method may include switching from the first type of random access occasions to the second type of random access occasions. The operations of 1215 may be performed in accordance with examples as disclosed herein. In some examples, aspects of the operations of 1215 may be performed by a RO type switching manager 1035 as described with reference to FIG. 10.

At 1220, the method may include transmitting one or more random access messages via one or more random access occasions of the second set of random access occasions during a second time period in accordance with the switch. The operations of 1220 may be performed in accordance with examples as disclosed herein. In some examples, aspects of the operations of 1220 may be performed by a random access manager 1030 as described with reference to FIG. 10.

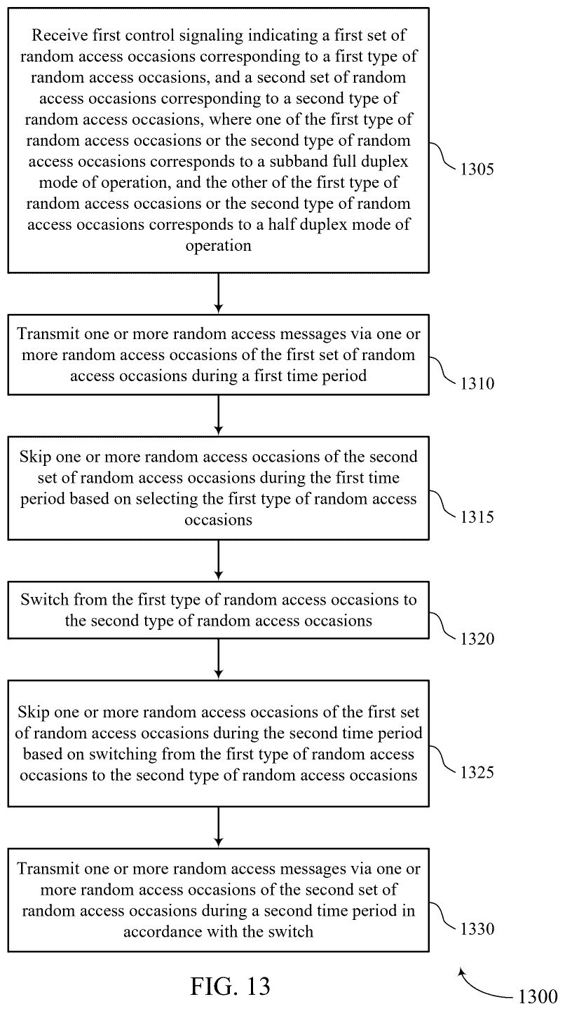

FIG. 13 shows a flowchart illustrating a method 1300 that supports random access occasion type switching timelines for subband full duplex devices in accordance with one or more aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The operations of 1305 may be performed in accordance with examples as disclosed herein. In some examples, aspects of the operations of 1305 may be performed by a RO configuration manager 1025 as described with reference to FIG. 10.

At 1310, the method may include transmitting one or more random access messages via one or more random access occasions of the first set of random access occasions during a first time period. The operations of 1310 may be performed in accordance with examples as disclosed herein. In some examples, aspects of the operations of 1310 may be performed by a random access manager 1030 as described with reference to FIG. 10.

At 1315, the method may include skipping one or more random access occasions of the second set of random access occasions during the first time period based on selecting the first type of random access occasions. The operations of 1315 may be performed in accordance with examples as disclosed herein. In some examples, aspects of the operations of 1315 may be performed by a RO type manager 1040 as described with reference to FIG. 10.

At 1320, the method may include switching from the first type of random access occasions to the second type of random access occasions. The operations of 1320 may be performed in accordance with examples as disclosed herein. In some examples, aspects of the operations of 1320 may be performed by a RO type switching manager 1035 as described with reference to FIG. 10.

At 1325, the method may include skipping one or more random access occasions of the first set of random access occasions during the second time period based on switching from the first type of random access occasions to the second type of random access occasions. The operations of 1325 may be performed in accordance with examples as disclosed herein. In some examples, aspects of the operations of 1325 may be performed by a RO type manager 1040 as described with reference to FIG. 10.

At 1330, the method may include transmitting one or more random access messages via one or more random access occasions of the second set of random access occasions during a second time period in accordance with the switch. The operations of 1330 may be performed in accordance with examples as disclosed herein. In some examples, aspects of the operations of 1330 may be performed by a random access manager 1030 as described with reference to FIG. 10.

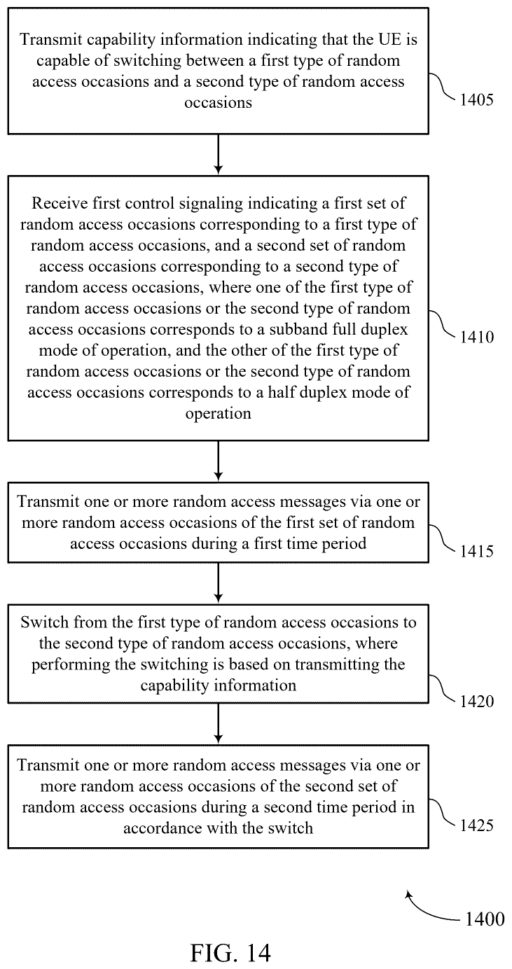

FIG. 14 shows a flowchart illustrating a method 1400 that supports random access occasion type switching timelines for subband full duplex devices in accordance with one or more aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1405, the method may include transmitting capability information indicating that the UE is capable of switching between a first type of random access occasions and a second type of random access occasions. The operations of 1405 may be performed in accordance with examples as disclosed herein. In some examples, aspects of the operations of 1405 may be performed by a capability information manager 1050 as described with reference to FIG. 10.

At 1410, the method may include receiving first control signaling indicating a first set of random access occasions corresponding to a first type of random access occasions, and a second set of random access occasions corresponding to a second type of random access occasions, where one of the first type of random access occasions or the second type of random access occasions corresponds to a subband full duplex mode of operation, and the other of the first type of random access occasions or the second type of random access occasions corresponds to a half duplex mode of operation. The operations of 1410 may be performed in accordance with examples as disclosed herein. In some examples, aspects of the operations of 1410 may be performed by a RO configuration manager 1025 as described with reference to FIG. 10.

At 1415, the method may include transmitting one or more random access messages via one or more random access occasions of the first set of random access occasions during a first time period. The operations of 1415 may be performed in accordance with examples as disclosed herein. In some examples, aspects of the operations of 1415 may be performed by a random access manager 1030 as described with reference to FIG. 10.

At 1420, the method may include switching from the first type of random access occasions to the second type of random access occasions, where performing the switching is based on transmitting the capability information. The operations of 1420 may be performed in accordance with examples as disclosed herein. In some examples, aspects of the operations of 1420 may be performed by a RO type switching manager 1035 as described with reference to FIG. 10.

At 1425, the method may include transmitting one or more random access messages via one or more random access occasions of the second set of random access occasions during a second time period in accordance with the switch. The operations of 1425 may be performed in accordance with examples as disclosed herein. In some examples, aspects of the operations of 1425 may be performed by a random access manager 1030 as described with reference to FIG. 10.

The following provides an overview of aspects of the present disclosure:

Aspect 1: A method for wireless communications at a UE, comprising: receiving first control signaling indicating a first set of random access occasions corresponding to a first type of random access occasions, and a second set of random access occasions corresponding to a second type of random access occasions, wherein one of the first type of random access occasions or the second type of random access occasions corresponds to a subband full duplex mode of operation, and the other of the first type of random access occasions or the second type of random access occasions corresponds to a half duplex mode of operation; transmitting one or more random access messages via one or more random access occasions of the first set of random access occasions during a first time period; switching from the first type of random access occasions to the second type of random access occasions; and transmitting one or more random access messages via one or more random access occasions of the second set of random access occasions during a second time period in accordance with the switch.

Aspect 2: The method of aspect 1, further comprising: skipping one or more random access occasions of the second set of random access occasions during the first time period based at least in part on selecting the first type of random access occasions; and skipping one or more random access occasions of the first set of random access occasions during the second time period based at least in part on switching from the first type of random access occasions to the second type of random access occasions.

Aspect 3: The method of any of aspects 1 through 2, wherein the first time period comprises a first association period corresponding to a first mapping between first synchronization signal blocks (SSBs) and a first plurality of random access occasions of the first set of random access occasions, the second set of random access occasions, or both, and the second time period comprises a second association period corresponding to a second mapping between second SSBs and a second plurality of random access occasions of the first set of random access occasions, the second set of random access occasions, or both.

Aspect 4: The method of any of aspects 1 through 3, wherein the first time period comprises a first association pattern period comprising a first set of association periods, and the second time period comprises a second association pattern period comprising a second set of association periods.

Aspect 5: The method of any of aspects 1 through 4, further comprising: receiving an indication of a threshold quantity of random access transmissions, wherein a quantity of the one or more random access messages transmitted via the first set of random access occasions during the first time period satisfies the threshold quantity of random access transmissions.

Aspect 6: The method of aspect 5, further comprising: refraining from transmitting any additional random access messages until expiration of the first time period, wherein switching from the first type of random access occasions to the second type of random access occasions is based at least in part on expiration of the first time period.

Aspect 7: The method of any of aspects 5 through 6, further comprising: transmitting one or more additional random access messages exceeding the threshold quantity of random access transmissions prior to expiration of the first time period, wherein switching from the first type of random access occasions to the second type of random access occasions is based at least in part on expiration of the first time period.

Aspect 8: The method of any of aspects 5 through 7, further comprising: initiation the switching from the first type of random access occasions to the second type of random access occasions prior to expiration of the first time period based at least in part on the quantity of the one or more random access messages transmitted via the first set of random access occasions during the first time period satisfying the threshold quantity of random access transmissions.

Aspect 9: The method of any of aspects 1 through 8, further comprising: initiating the first time period upon transmission of a first random access message via a random access occasion of the first type of random access occasions; resetting the first time period each time the UE transmits another random access message via a random access occasion of the first type of random access occasions; and refraining from transmitting random access messages via one or more random access occasions of the second type of random access occasions that occur within the first time period or the reset first time period.

Aspect 10: The method of aspect 9, wherein switching from the first type of random access occasions to the second type of random access occasions is based at least in part on expiration of the first time period subsequent to a most recent transmission of the one or more random access messages via the first set of random access occasions.

Aspect 11: The method of any of aspects 1 through 10, further comprising: transmitting capability information indicating that the UE is capable of switching between the first type of random access occasions or the second type of random access occasions, wherein performing the switching is based at least in part on transmitting the capability information.

Aspect 12: A UE for wireless communications, comprising one or more memories storing processor-executable code, and one or more processors coupled with the one or more memories and individually or collectively operable to execute the code to cause the UE to perform a method of any of aspects 1 through 11.

Aspect 13: A UE for wireless communications, comprising at least one means for performing a method of any of aspects 1 through 11.

Aspect 14: A non-transitory computer-readable medium storing code for wireless communications, the code comprising instructions executable by one or more processors to perform a method of any of aspects 1 through 11.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components. ”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a first set of random access occasions corresponding to a first type of random access occasions, and a second set of random access occasions corresponding to a second type of random access occasions, wherein one of the first type of random access occasions or the second type of random access occasions corresponds to a subband full duplex mode of operation, and the other of the first type of random access occasions or the second type of random access occasions corresponds to a half duplex mode of operation;
transmit one or more random access messages via one or more random access occasions of the first set of random access occasions during a first time period;
switch from the first type of random access occasions to the second type of random access occasions; and
transmit one or more random access messages via one or more random access occasions of the second set of random access occasions during a second time period in accordance with the switch.

2. The UE of claim 1, wherein the one or more processors are individually or collectively further operable to execute the code to cause the UE to:
skip one or more random access occasions of the second set of random access occasions during the first time period based at least in part on selecting the first type of random access occasions; and
skip one or more random access occasions of the first set of random access occasions during the second time period based at least in part on the switch from the first type of random access occasions to the second type of random access occasions.

3. The UE of claim 1, wherein the first time period comprises a first association period corresponding to a first mapping between first synchronization signal blocks (SSBs) and a first plurality of random access occasions of the first set of random access occasions, the second set of random access occasions, or both, and the second time period comprises a second association period corresponding to a second mapping between second SSBs and a second plurality of random access occasions of the first set of random access occasions, the second set of random access occasions, or both.

4. The UE of claim 1, wherein the first time period comprises a first association pattern period comprising a first set of association periods, and the second time period comprises a second association pattern period comprising a second set of association periods.

5. The UE of claim 1, wherein the one or more processors are individually or collectively further operable to execute the code to cause the UE to:
receive an indication of a threshold quantity of random access transmissions, wherein a quantity of the one or more random access messages transmitted via the first set of random access occasions during the first time period satisfies the threshold quantity of random access transmissions.

6. The UE of claim 5, wherein the one or more processors are individually or collectively further operable to execute the code to cause the UE to:
refrain from transmitting any additional random access messages until expiration of the first time period, wherein the switch from the first type of random access occasions to the second type of random access occasions is based at least in part on expiration of the first time period.

7. The UE of claim 5, wherein the one or more processors are individually or collectively further operable to execute the code to cause the UE to:
transmit one or more additional random access messages exceeding the threshold quantity of random access transmissions prior to expiration of the first time period, wherein the switch from the first type of random access occasions to the second type of random access occasions is based at least in part on expiration of the first time period.

8. The UE of claim 5, wherein the one or more processors are individually or collectively further operable to execute the code to cause the UE to:
initiate the switch from the first type of random access occasions to the second type of random access occasions prior to expiration of the first time period based at least in part on the quantity of the one or more random access messages transmitted via the first set of random access occasions during the first time period satisfying the threshold quantity of random access transmissions.

9. The UE of claim 1, wherein the one or more processors are individually or collectively further operable to execute the code to cause the UE to:
initiate the first time period upon transmission of a first random access message via a random access occasion of the first type of random access occasions;
reset the first time period each time the UE transmits another random access message via a random access occasion of the first type of random access occasions; and
refrain from transmitting random access messages via one or more random access occasions of the second type of random access occasions that occur within the first time period or the reset first time period.

10. The UE of claim 9, wherein the switch from the first type of random access occasions to the second type of random access occasions is based at least in part on expiration of the first time period subsequent to a most recent transmission of the one or more random access messages via the first set of random access occasions.

11. The UE of claim 1, wherein the one or more processors are individually or collectively further operable to execute the code to cause the UE to:
transmit capability information indicating that the UE is capable of switching between the first type of random access occasions or the second type of random access occasions, wherein performing the switching is based at least in part on transmitting the capability information.

12. A method for wireless communications at a user equipment (UE), comprising:
receiving first control signaling indicating a first set of random access occasions corresponding to a first type of random access occasions, and a second set of random access occasions corresponding to a second type of random access occasions, wherein one of the first type of random access occasions or the second type of random access occasions corresponds to a subband full duplex mode of operation, and the other of the first type of random access occasions or the second type of random access occasions corresponds to a half duplex mode of operation;
transmitting one or more random access messages via one or more random access occasions of the first set of random access occasions during a first time period;
switching from the first type of random access occasions to the second type of random access occasions; and
transmitting one or more random access messages via one or more random access occasions of the second set of random access occasions during a second time period in accordance with the switching.

13. The method of claim 12, further comprising:
skipping one or more random access occasions of the second set of random access occasions during the first time period based at least in part on selecting the first type of random access occasions; and
skipping one or more random access occasions of the first set of random access occasions during the second time period based at least in part on switching from the first type of random access occasions to the second type of random access occasions.

14. The method of claim 12, wherein the first time period comprises a first association period corresponding to a first mapping between first synchronization signal blocks (SSBs) and a first plurality of random access occasions of the first set of random access occasions, the second set of random access occasions, or both, and the second time period comprises a second association period corresponding to a second mapping between second SSBs and a second plurality of random access occasions of the first set of random access occasions, the second set of random access occasions, or both.

15. The method of claim 12, wherein the first time period comprises a first association pattern period comprising a first set of association periods, and the second time period comprises a second association pattern period comprising a second set of association periods.

16. The method of claim 12, further comprising:
receiving an indication of a threshold quantity of random access transmissions, wherein a quantity of the one or more random access messages transmitted via the first set of random access occasions during the first time period satisfies the threshold quantity of random access transmissions.

17. The method of claim 12, further comprising:
initiating the first time period upon transmission of a first random access message via a random access occasion of the first type of random access occasions;
resetting the first time period each time the UE transmits another random access message via a random access occasion of the first type of random access occasions; and
refraining from transmitting random access messages via one or more random access occasions of the second type of random access occasions that occur within the first time period or the reset first time period.

18. The method of claim 17, wherein switching from the first type of random access occasions to the second type of random access occasions is based at least in part on expiration of the first time period subsequent to a most recent transmission of the one or more random access messages via the first set of random access occasions.

19. The method of claim 12, further comprising:
transmitting capability information indicating that the UE is capable of switching between the first type of random access occasions or the second type of random access occasions, wherein performing the switching is based at least in part on transmitting the capability information.

20. A non-transitory computer-readable medium storing code for wireless communications, the code comprising instructions executable by one or more processors to:
receive first control signaling indicating a first set of random access occasions corresponding to a first type of random access occasions, and a second set of random access occasions corresponding to a second type of random access occasions, wherein one of the first type of random access occasions or the second type of random access occasions corresponds to a subband full duplex mode of operation, and the other of the first type of random access occasions or the second type of random access occasions corresponds to a half duplex mode of operation;
transmit one or more random access messages via one or more random access occasions of the first set of random access occasions during a first time period;
switch from the first type of random access occasions to the second type of random access occasions; and
transmit one or more random access messages via one or more random access occasions of the second set of random access occasions during a second time period in accordance with the switching.
